(19) United States
(12) Patent Application Publication
(10) Pub. No.: US 2012/0238328 A1
(43) Pub. Date: Sep. 20, 2012

(54) METHOD FOR DISPLAYING MESSAGE LIST ON THE TERMINAL AND TERMINAL

(75) Inventor: Guoquan Zhang, Beijing (CN)

(73) Assignee: Huawei Device Co.,Ltd., Shenzhen (CN)

(21) Appl. No.: 13/482,780

(22) Filed: May 29, 2012

Related U.S. Application Data
(63) Continuation of application No. PCT/CN2011/078983, filed on Aug. 26, 2011.

(30) Foreign Application Priority Data
Aug. 26, 2010 (CN) 201010268776.3

(51) Int. Cl. H04W 88/02

(52) U.S. Cl. 455/566

(57) ABSTRACT

A method for displaying a message list on a terminal and a terminal are provided according to the embodiments of the present disclosure. The method includes: obtaining, by a terminal, a trigger to display a message list; calculating the height occupied by a message in the message list on the screen at least according to a preset height, where the height of the message does not exceed the preset height, the preset height is less than the height of the screen, and at least two lines of message contents can be displayed within the height of the message on the screen; and displaying, by the terminal, the message list. When the terminal displays the message list, the terminal can not only concurrently display multiple messages but also display the content of each message so that a user can view the contents of multiple messages on the screen at the same time.

### CROSS-REFERENCE TO RELATED APPLICATIONS

This application is a continuation of International Application No. PCT/CN2011/078983, filed on Aug. 26, 2011, which claims priority to Chinese Patent Application No. 201010268776.3, filed on Aug. 26, 2010, both of which are hereby incorporated by reference in their entireties

### FIELD

The present disclosure relates to terminal display technologies, and in particular, to a method for displaying a message list on the terminal and a terminal.

### BACKGROUND

Receiving, sending, and displaying messages (Message) is a basic function of the terminal. Before displaying messages, a terminal displays a message list so that the user who uses the terminal can view the messages through the message list.

For example, from the aspect of a user, before viewing the messages, the user opens an inbox (Inbox) first to view the message list. A message list normally uses user name or number as the ID of a message. The user will view the messages sent from a user name or number after triggering the user name or number. From the aspect of a terminal, the terminal displays a message list after obtaining the trigger used by the user to open the inbox. The terminal displays a message after obtaining the trigger used by the user to this message.

As another example: some terminals do not use the inbox to store and display a message list but use a conversation (Conversation) to store and display the message list. A conversation displays a message list comprised of all messages sent by the same user name or number. The message list displays all or most part of contents of each message. As shown in FIG. 1, the terminal displays a message list comprised of the messages sent from 10658000.The terminal displays a message list comprised of all messages sent by a user name or number after obtaining the trigger used by the user to a conversation. The terminal displays a message on a full screen after obtaining the trigger used by the user to this message.

After carefully researching into the prior art, the inventor finds that the terminal displays only a user name and number from which the message is sent, displays few contents of the message at most when the terminal uses the inbox to display message list. Under such circumstances, the user cannot learn all contents of each message through the message list. Although the terminal can use a conversation to display all contents of a message, if the message has too many contents to display, the number of messages concurrently displayed on the screen is decreased. In this case, the user cannot view the contents of multiple messages concurrently on the screen, which brings inconvenience to the subsequent operations for the messages, such as the view, find, and delete operation.

### SUMMARY

Various embodiments of the present disclosure provide a method for displaying a message list on the terminal and a terminal so that the screen can display multiple messages concurrently when the terminal displays a message list. Therefore the user can view contents of multiple messages concurrently on the screen.

A method for displaying a message list on a terminal includes: obtaining, by the terminal, a trigger to display the message list; calculating, by the terminal, a height occupied by each message in the message list on a screen at least according to a preset height, where the height occupied by each message in the message list on the screen does not exceed the preset height, the preset height is less than the screen height, and at least two lines of message contents can be displayed within the height occupied by each message on the screen; and displaying, by the terminal, the message list.

A terminal includes: an obtaining unit, configured to obtain a trigger to display a message list; a screen, configured to display the message list; and a processing unit, configured to calculate a height occupied by each message in the message list on the screen at least according to a preset height when the obtaining unit obtains the trigger to display the message list, where the height does not exceeded the preset height, the preset height is less than the screen height, and at least two lines of message contents can be displayed within the height occupied by each message on the screen.

According to the embodiments of the present disclosure, at least two lines of message contents can be displayed within the height occupied by each message on the screen, so when a user queries the message list, the user can learn about the content of the message on the screen. Therefore, the objective of viewing multiple messages on the screen concurrently is achieved so that the user determines the operation on the message. Accordingly, the efficiency of operations such as viewing, finding, and deleting messages is improved for the user.

### BRIEF DESCRIPTION OF THE DRAWINGS

To make the technical solutions of the present disclosure clearer, the accompanying drawings for illustrating the embodiments of the present disclosure or the prior art are outlined below. Apparently, the accompanying drawings are for the exemplary purpose only, and persons of ordinary skills in the art can derive other drawings from such accompanying drawings without any creative effort.

FIG. 1 is a schematic view of using a conversation by a terminal to display a message list in the prior art;

FIG. 2 is a schematic view illustrating the height and length of the screen of a terminal according to an embodiment of the present disclosure;

FIG. 3 is a flowchart of a method for displaying a message list on the terminal according to a first embodiment of the present disclosure;

FIG. 4 is a flowchart of a method for displaying a message list on the terminal according to a second embodiment of the present disclosure; and

FIG. 5 is a structure view of a terminal according to an embodiment of the present disclosure.

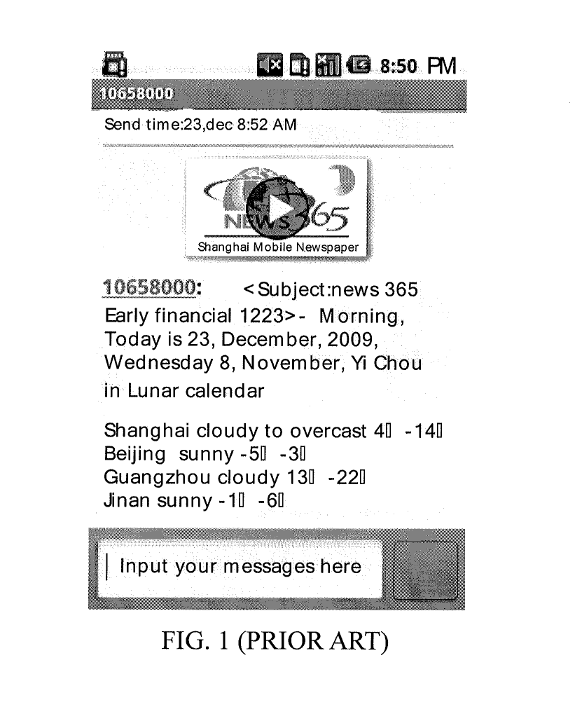

### DETAILED DESCRIPTION OF THE EMBODIMENTS

The technical solutions of the embodiments of the present disclosure are clearly and completely described below with reference to accompanying drawings. Evidently, the embodiments described below are merely part of rather than all of the embodiments of the present disclosure. Those skilled in the art can derive other embodiments from the embodiments given herein without making any creative effort, and all such embodiments fall within the protection scope of the present disclosure.

Before description of the embodiments, the professional knowledge involved in the embodiments of the present disclosure is introduced firstly.

The message in the embodiments of the present disclosure at least includes short message (SM , Short Message) and multimedia messaging service (MMS, Multimedia Messaging Service) message. The content of a short message is generally displayed in a text form. An MMS message contains not only texts, but also pictures, videos, audios, and animations. In a short message or MMS message, if the message contains too many contents, the message can be displayed on the screen in multiple pages.

According to the embodiments of the present disclosure, the terminal can store and display a message list in the form of a mailbox or conversation. A message list can be one containing the messages received by the terminal. In such a case, the mailbox is called an inbox. A message list may also be one containing the messages send from the terminal. In such a case, the mailbox is called an outbox. A message list can also be one containing the messages edited but not sent (also called draft) by the terminal. In such a case, the mailbox is called a draft.

In the current terminal, the messages in the message list are generally displayed on the screen in the vertical direction. For example, if the terminal uses a mailbox to store and display the message list, the user name or number in the message list is displayed in the vertical direction according to the processing (receiving, sending, or editing) sequence of the messages. Each user name or number represents a message. For another example, if the terminal uses the conversation to store and display the message list, the contents of the messages in the message list will be displayed in the vertical direction according to the processing (receiving, sending, or editing) sequence of the messages.

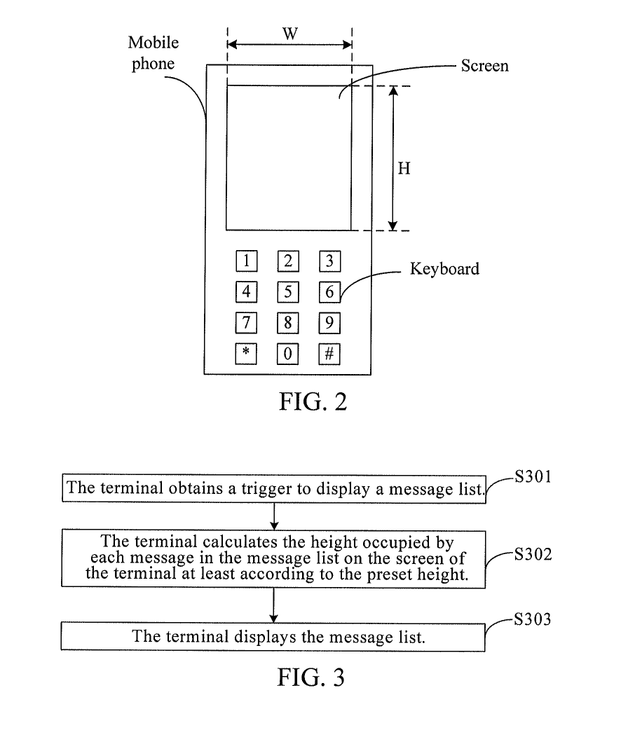

The terminal in the embodiments of the present disclosure can be a mobile phone (also called handset). According to the embodiments of the present disclosure, the screen height refers to the length of the screen in the vertical direction. Correspondingly, the length of the screen in the horizontal direction is also called the width of the screen. As shown in FIG. 2, “H” represents the height of the screen and “W” represents the width of the screen.

The following describes a method for displaying a message list on a terminal. As shown in FIG. 3, the method includes as follows.

S301: The terminal obtains a trigger to display the message list.

In the aspect of input mode, the terminals can be classified into keyboard terminal and touch screen terminal.

The user who uses a keyboard terminal may perform operation on the terminal through the keyboard. The terminal provides the corresponding functions after obtaining a trigger to the keyboard from the user. If the user triggers the terminal to display the message list through the keyboard, the terminal obtains the trigger to display the message list from the user.

The user who uses a touch screen terminal may perform operation on the terminal through the finger or touch kit. The terminal provides the corresponding functions after obtaining a trigger to the touch kit from the user. If the user triggers the terminal to display the message list by touching the screen with the finger or touch kit, the terminal obtains the trigger to display the message list by touching the screen with the finger or touch kit.

If the terminal stores and displays the message list in the form of a mailbox, the user can trigger the terminal to open a mailbox. In this manner, the terminal obtains the trigger to open the mailbox. If the terminal stores and displays the message list in the form of a conversation, the user can trigger the terminal to open a conversation. In this manner, the terminal obtains the trigger to open the conversation.

S302: The terminal calculates a height occupied by each message in the message list on the screen at least according to a preset height, where the height does not exceeded the preset height, the preset height is less than a screen height, and at least two lines of message contents are displayed within the height occupied by each message on the screen.

After obtaining the trigger to display the message list, the terminal displays the message list. The message in the message list can be an SM or an MMS message. The message list can be one containing the messages received by the terminal, containing the messages sent by the terminal, or containing the messages edited but not sent by the terminal.

According to the embodiments of the present disclosure, a height can be preset, and the height is less than the screen height. The height occupied by each message on the screen does not exceed a preset height. When the message list is displayed on the screen, at least two messages can be displayed concurrently, wherein the content of one message can be partially displayed on the screen. For example, of two neighboring messages, if a previous message occupies 80% of the screen height and a next message also occupies 80% of the screen height; however, when a previous message is displayed at a height of 80% of the screen height, a next message is displayed at a height of 20% of the screen height, and the next message's content that is not displayed and occupies 60% of the screen height can be displayed when the user presses the DOWN arrow key, or drags the vertical scrollbar on the message list. When the user presses the DOWN arrow key to activate a next message, the activated message is displayed with the preset height for its display (80% of the screen height). The less the height occupied by each message in the message list on the screen is set, the more messages can be displayed on the screen when the message list is displayed on the screen.

In embodiments of the disclosure, the wording “activated” message means that the message is in a valid state. For example, the message is highlighted by setting background in different colors, invert colors, or small animations.

A terminal calculates the height occupied by each message in the message list on the screen at least according to the preset height. The height occupied by each message on the screen can be preset to be the same, but cannot exceed the preset height.

In a mailbox displaying mode, a height occupied by each message in the message list on the screen is calculated according to the preset height and the activated state of the message. For example, the preset height is 40% of the screen height, if the height occupied by each message on the screen is the same, the height occupied by each message on the screen can be half of the preset height (20% of the screen height). For the activated message, the height occupied by each message on the screen is the preset height (40% of the screen height). For the unactivated message, the height occupied by each message on the screen can be half of the preset height. When a message list is obtained, four messages (containing an activated message) or five unactivated messages can be displayed on the same screen.

For the message list containing SM and MMS messages, a height occupied by each message in the message list on the screen is calculated according to the preset height and a message type. For example, if the preset height is 40% of the screen height, the height occupied by SM on the screen can be half of the preset height (20% of the screen height). The height occupied by MMS message on the screen is the preset height (40% of the screen height).

For a better understanding, two examples are described for illustrating purposely. It is obvious that those skilled in the art can set parameters affecting the calculation of the height occupied by each message on the screen and the detailed calculation process in the inspiration of the embodiments of the present disclosure, and can finally ensure that the height occupied by each message on the screen does not exceeded the preset height. However, the method for calculating the height occupied by each message is not limited to that described in the embodiments of the present disclosure.

S303: The terminal displays the message list.

In the embodiments of the present disclosure, the height occupied by each message in a message list on the screen can be the same. In this case, after obtaining the trigger to display the message list, the terminal can calculate the height occupied by the message on the screen according to the preset height, and calculate the first quantity of the messages that can be displayed concurrently on the screen according to the screen height and the height occupied by each message on the screen. In such a case, when the terminal displays the message list, the screen displays messages of the first quantity concurrently.

In the embodiments of the present disclosure, the height occupied by each message in a message list on the screen may not be completely the same. In this case, the terminal can calculate the height occupied by multiple messages in the message list on the screen according to the preset height, calculate the second quantity of messages that can be displayed concurrently on the screen according the screen height and the height occupied by each message in the message list on the screen. In such a case, when the terminal displays the message list, the screen displays messages of the second quantity concurrently.

When the trigger, which is obtained by the terminal, to display the message list is the trigger to open a mailbox, step 303 may be specifically: the terminal displays the message list in the form of a mailbox.

When the trigger, which is obtained by the terminal, to display the message list is the trigger to a conversation, step 303 may be specifically: the terminal displays the message list in the form of a conversation.

The height occupied by each message on the screen can display at least two lines of contents, so the user can learn about the messages from the displayed contents when the user views the message list. In this way, multiple messages can be viewed concurrently on the screen, and the user can decide whether to trigger to view the message in full screen or to directly cancel the message that the user does not concern, so as to increase the efficiency of operations such as the message viewing, finding, and deleting.

Till now, the method for displaying a message list is implemented according to the embodiments of the present disclosure.

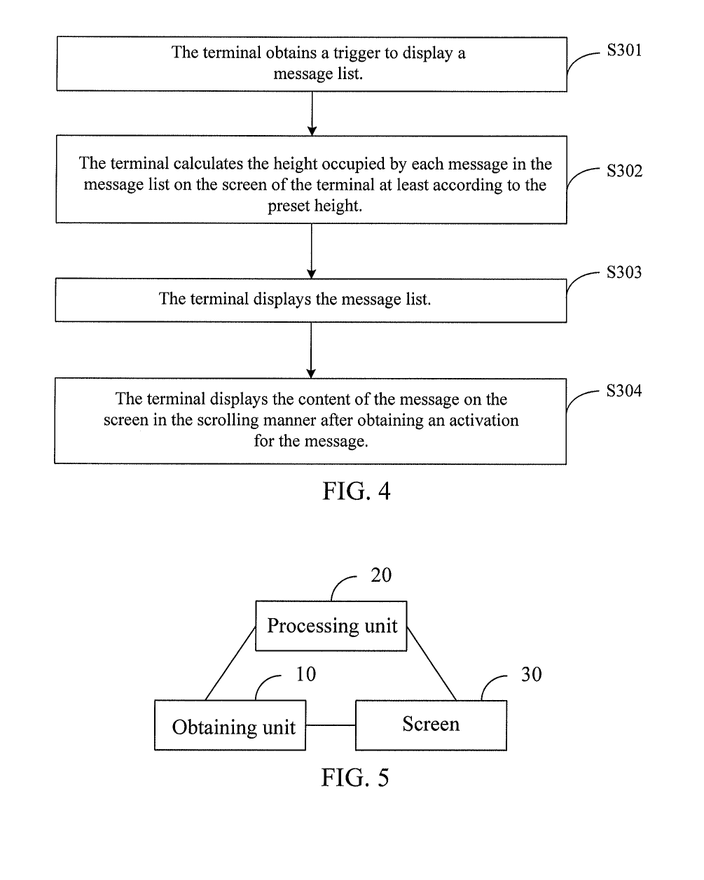

As shown in FIG. 4, the method further includes step S304: The terminal displays the content of the message on the screen in the horizontal scrolling manner after obtaining an activation for the message.

In the embodiments of the present disclosure, after the terminal displays the message list to the user, the user can activate the current displayed message. Then the terminal displays the content of the message on the screen in the horizontal scrolling manner. The message can be scrolled automatically in the horizontal direction or scrolled horizontally under the control of the user. The horizontal scrolling according to the embodiments of the present disclosure normally takes one page, on which the current activated message in the message list is displayed, as a basic unit of the scrolling change. For example, when the contents of the first three lines of the current activated message are displayed in the message list, after one horizontal scrolling, the contents of the fourth line to sixth line of the message are displayed (three lines are displayed as one page of the message in the message list). After a second horizontal scrolling, the contents of the seventh line to ninth line of the message are displayed, and so on. If the terminal displays a message list to the user, each message can be dragged in the horizontal direction under the control of the user, and the user can drag the desired message in the horizontal direction. In this manner, the terminal obtains the trigger to scroll the preceding messages in the horizontal direction on the screen. Optionally, when the message is activated, the number of the page, on which the current massage in the message list is displayed, among the total pages of the message can be calculated, and the number of the current page and the number of the total pages are displayed. This brings more convenience for the user to view the message.

After the terminal described in S304 obtains a trigger to a message, and before the content of the message is displayed on the screen in the horizontal scrolling manner, the process may further include: the terminal adds a horizontal scrolling indication sign for the activated message on the screen. When the terminal obtains a trigger to scroll the message in a horizontal direction, the process of displaying the content of the message on the screen in the horizontal scrolling manner is performed.

The horizontal scrolling indication sign can be a horizontal scrollbar that can be located on the top or bottom of the current activated message and can be dragged. It can also be an indicator that can be dragged to the left and right directions, and can be located on the left and right sides of the current activated message or located on the left or right side of the current message. The scrolling can be operated by touching with a touch kit or finger, or can be operated by using left or right arrow keys by the user to scroll the content of the message to the left or right direction.

In the embodiments of the present disclosure, before the screen is scrolled for displaying the content of a message in the horizontal direction, the terminal may determine the quantity of the message that is to be displayed on the screen at a time. Specifically, the terminal can calculate the quantity of message that is to be displayed on the screen at a time according to the height and width of the screen and the height occupied by the message on the screen. After the terminal obtains a trigger to scroll the message in the horizontal direction, the content of the message is scrolled horizontally, and the screen displays the content of the message of the calculated quantity. If the terminal obtains a trigger to scroll the message in the horizontal direction, the content of the message is scrolled continually in the horizontal direction, and the screen displays the content of the message of the calculated quantity. Each time the message is scrolled, the quantity of the message displayed on the screen can be the same, but the displayed contents can be different.

In the embodiments of the present disclosure, after the terminal obtains an activation for a message, a function selection for processing the message can be added at the back end of the message on the screen. For example, it is assumed that the user drags a message in the horizontal direction, after the terminal displays all contents of this message, the terminal can display a function selection list. The function selection list includes: deleting, modifying, and replying functions. After the user select a function, that is, the terminal obtains a trigger to the function from the user, the terminal provides corresponding functions.

It should be noted that if the message is an MMS message, the subject (subject) of the MMS message is displayed first when the message list is displayed. If the subject has few contents, the first-page content of the MMS message can also be displayed. The content of the first page can be a text and a picture (a picture can be minified in size according to a preset proportion). After each MMS message is scrolled at a time in the horizontal direction, the screen may display one-page content of the MMS message. In such a case, the quantity of one-page content of the MMS message is the quantity of the MMS message contents displayed on the screen at a time.

The terminal displays the content of the activated message on the screen in the horizontal scrolling manner so that the user can learn as many messages as possible in the message list without triggering to display the message in full screen. The user can read the activated message at will by adding a horizontal scrolling indication sign, which increases the efficiency of viewing the messages. The user can fast operate the activated message by adding a function selection at the back end of the message, which improves the efficiency of operating and managing the messages.

Corresponding to the preceding method, one embodiment of the present disclosure provides a terminal. As shown in FIG. 5, the terminal includes:

an obtaining unit 10, configured to obtain a trigger to display a message list;

a processing unit 20, configured to calculate a height occupied by each message in the message list on a screen at least according to a preset height when the obtaining unit 10 obtains the trigger to display the message list, where the height occupied by each message does not exceeded the preset height, the preset height is less than a screen height, and at least two lines of message contents can be displayed within the height occupied by each message on the screen displays; and

a screen 30, configured to display the message list.

In the embodiments of the present disclosure, the height occupied by each message in the message list on the screen 30 can be the same. In this case, the processing unit 20 further includes: a first calculating subunit, configured to calculate the first quantity of messages concurrently displayed on the screen 30 according to the height of the screen 30 and the height occupied by each message on the screen 30. The screen 30 is further configured to display the messages of the first quantity concurrently.

In one embodiment of the present disclosure, the height occupied by each message in a message list on the screen 30 is not completely the same. In this case, the processing unit further includes: a second calculating unit, configured to calculate the second quantity of messages concurrently displayed on the screen 30 according to the height of the screen 30 and the height occupied by each message among the multiple messages on the screen 30. The screen 30 is further configured to display the messages of the second quantity concurrently.

The screen 30, further configured to display the message list in the form of a mailbox after obtaining a trigger to open the mailbox, and display the message list in the form of a conversation after obtaining a trigger to open the conversation.

The obtaining unit 10 is further configured to obtain an activation for a message. The screen 30 is further configured to display the content of the message in the horizontal scrolling manner after the obtaining unit 10 obtains an activation for the message.

The processing unit preferably includes: a sign adding subunit, configured to add a horizontal scrolling indication sign for the activated message on the screen 30, after the obtaining unit 10 obtains an activation for the message and before the content of the message is displayed in the horizontal scrolling manner on the screen 30.

In the one embodiment of the present disclosure, preferably, the processing unit further includes: a function adding subunit, configured to add a function selection for processing the message at the back end of the message on the screen 30, after the obtaining unit 10 obtains an activation for the message.

Because the contents of the embodiments of the terminal are much similar to the contents of the method embodiments of the present disclosure, the function of each unit and the mapping relationships between units of the terminal according to the embodiments of the terminal can be referred to the related description in the method embodiments, and are not detailed here.

To sum up, in one embodiment of the present disclosure, the height occupied by a message in a message list on the screen does not exceed the preset height. The preset height is less than the screen height, which ensures that multiple messages are displayed concurrently on the screen. Furthermore, the screen displays the content of the message in the horizontal scrolling manner, which ensures that the content of the message is displayed on the screen. In this way, when the terminal displays a message list, the terminal not only can display the multiple messages concurrently, but also can display the content of the message, so that the user can view the contents of multiple messages concurrently on the screen.

It should be noted that persons of ordinary skill in the art may understand that all or part of the steps of the method according to the embodiments of the present disclosure may be implemented by a program instructing relevant hardware. The program may be stored in a computer readable storage medium. When the program runs, the process of the method embodiments can be executed. The storage medium may be a magnetic disk, a Compact Disk Read-Only Memory (CD-ROM), a Read-Only Memory (ROM) or a Random Access Memory (RAM).

It should be noted that the above descriptions are merely exemplary embodiments of the present disclosure, and those skilled in the art may make various improvements and refinements without departing from the principle of the disclosure. All such modifications and refinements are intended to be covered by the protection scope of the present disclosure.

1. A method for displaying a message list on a terminal, comprising:
obtaining, by a terminal, a trigger to display a message list;
calculating, by the terminal, a height occupied by each message in the message list on a screen, wherein the height occupied by each message on the screen does not exceed a preset height, the preset height is less than the screen height, and at least two lines of message contents can be displayed within the height occupied by each message on the screen; and
displaying, by the terminal, the message list.

2. The method according to claim 1, wherein calculating the height occupied by each message in the message list on the screen further comprises calculating according to the preset height.

3. The method according to claim 1, wherein calculating the height occupied by each message in the message list on the screen further comprises one of the following: calculating according to the preset height and activated state of the message, and calculating according to the preset height and a message type.

4. The method according to claim 1, further comprising:
calculating the number of messages concurrently displayed on the screen according to the screen height and the height occupied by each message on the screen.

5. The method according to claim 1, further comprising:
displaying the content of the message on the screen in the horizontal scrolling manner after obtaining an activation for the message.

6. The method according to claim 5, wherein after the terminal obtains the activation for the message and before the terminal displays the content of the message on the screen in the horizontal scrolling manner, the method further comprises:
adding a horizontal scrolling indication sign to the activated message on the screen, and displaying the content of the message on the screen in the horizontal scrolling manner after obtaining a trigger to scroll the message horizontally.

7. The method according to claim 1, wherein the trigger to display the message comprises one of the following: a trigger to open a mailbox and a trigger to open a conversation.

8. The method according to claim 1, wherein the message list comprises at least one of the following: a short message (SM) and a multimedia messaging service (MMS) message.

9. The method according to claim 1, wherein the message list comprises one of the following: a message list comprising messages received by the terminal, a message list comprising messages sent by the terminal, and a message list comprising messages edited but not sent by the terminal.

10. The method according to claim 5, wherein after the terminal obtains the activation for the message, the terminal adds a function selection for processing the message at the back end of each message, wherein the function selection comprises: deleting the message, modifying the message, or replying the message.

11. A terminal, comprising:
an obtaining unit, configured to obtain a trigger to display a message list;
a screen, configured to display the message list; and
a processing unit, configured to calculate a height occupied by each message in the message list on the screen, wherein the height occupied by each message on the screen does not exceed the preset height, the preset height is less than the screen height, and at least two lines of message contents can be displayed within the height occupied by each message on the screen.

12. The terminal according to claim 11, wherein the processing unit further comprises:
a first calculating subunit, configured to calculate the height occupied by each message in the message list on the screen of the terminal according to the preset height;
a second calculating subunit, configured to calculate the height occupied by each message in the message list on the screen of the terminal, according to the preset height and a message type, or according to the preset height and activated state of the message;
a third calculating subunit, configured to calculate the number of messages concurrently displayed on the screen, according to the height of the screen and the height occupied by each message on the screen.

13. The terminal according to claim 11, wherein
the obtaining unit is further configured to obtain an activation for a message; and
the screen is further configured to display the content of the message on the screen in the horizontal scrolling manner after obtaining, by the obtaining unit, the activation for the message.

14. The terminal according to claim 13, wherein the processing unit further comprises:
a sign adding subunit, configured to add a horizontal scrolling indication sign for the activated message after obtaining the a ctivation for the message and before displaying the content of the message in the horizontal scrolling manner on the screen.

15. The terminal according to any one of claim 11, wherein the screen is further configured to display the message list in the form of a mailbox when the terminal obtains a trigger to open the mailbox.

16. The terminal according to claim 13, wherein the processing unit further comprises:
a function adding subunit, configured to add a function selection for processing the message at the back end of the message on the screen after obtaining, by the obtaining unit, the activation for the message, wherein the function selection comprises: deleting the message, modifying the message, or replying the message.

17. The terminal according to any one of claim 11, wherein the screen is further configured to display the message list in the form of a conversation when the terminal obtains a trigger to open the conversation.
